(19) United States
(12) Patent Application Publication
(10) Pub. No.: US 2014/0104597 A1
(43) Pub. Date: Apr. 17, 2014

(54) DUAL-SPECTROSCOPY DETECTION APPARATUS AND METHOD

(71) Applicant: Brian M. Sutin, Claremont, CA (US)

(72) Inventor: Brian M. Sutin, Claremont, CA (US)

(73) Assignee: Hamilton Sundstrand Space Systems International, Inc., Windsor Locks, CT (US)

(21) Appl. No.: 13/650,327

(22) Filed: Oct. 12, 2012

(51) Int. Cl. G01J 3/44; H01J 49/26

(52) U.S. Cl. 356/72

(57) ABSTRACT

A dual-spectroscopy detection apparatus includes a mass spectrometer, a sample collection system connected to the mass spectrometer and a Raman spectrometer that is operatively coupled with the sample collection system.

### BACKGROUND

This disclosure relates to spectroscopy instruments that are known and used for identifying the sample matter. Mass spectrometry and Raman spectrometry are examples of spectroscopic techniques. Mass spectrometry utilizes a mass-to-charge ratio of vaporized sample matter to determine elemental composition. Raman spectrometry uses vibrational, rotational or other frequency modes in sample matter and Raman scattering of light to identify composition.

### SUMMARY

Disclosed is a dual-spectroscopy detection apparatus that includes a mass spectrometer, a sample collection system connected to the mass spectrometer and a Raman spectrometer that is operatively coupled with the sample collection system

Also disclosed is a method for dual-spectroscopy. The method includes introducing a sample into a sample collection system, collecting Raman spectrometer data from the sample at a location in the sample collection system, transporting the sample from the sample collection system into a mass spectrometer and collecting spectrometer data from the sample in the mass spectrometer.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 schematically shows an example dual-spectroscopy detection apparatus.

FIG. 2 schematically shows another example dual-spectroscopy detection apparatus.

FIG. 3 shows a variation of the dual-spectroscopy detection apparatus of FIG. 2.

FIG. 4 shows a variation of the dual-spectroscopy detection apparatus of FIG. 2.

FIG. 5 shows a variation of the dual-spectroscopy detection apparatus of FIG. 2.

FIG. 6 shows a variation of the dual-spectroscopy detection apparatus of FIG. 2.

FIG. 7 shows a method for dual-spectroscopy.

### DETAILED DESCRIPTION

FIG. 1 schematically shows an example of a dual-spectroscopy detection apparatus 20 (hereafter “apparatus 20”). As an example, the apparatus 20 can be used for bio-chemical detection. As will be described in more detail, the apparatus 20 provides dual functionality with regard to the type of spectroscopy techniques that are used and thereby provides enhanced bio-chemical detection.

As can be appreciated, individual instruments that contain hardware and software related to a single spectroscopic technique are common in the analysis and identification of compositions. However, each spectroscopic technique has drawbacks that make detection of a wide variety of compositions or mixtures difficult. The dual-spectroscopy detection apparatus 20 operatively combines two different spectroscopy instruments into a single instrument and thus enhances detection and identification of compositions that may contain chemical matter, biological matter and mixtures thereof.

As shown in FIG. 1, the apparatus 20 includes a mass spectrometer 22 and a sample collection system 24 connected to the mass spectrometer 22. A mass spectrometer typically includes an ion source, a mass analyzer and a detector, the details of which are known. A Raman spectrometer 26 is operatively coupled with the sample collection system 24, as indicated by the light L emitted from the Raman spectrometer 26 through the sample collection system 24 and back into the Raman spectrometer. A Raman spectrometer typically includes a light laser source, one or more lenses, a filter and a detector, the details of which are also known. The apparatus 20 may be a laboratory instrument or a portable device, for environmental monitoring.

In operation, the apparatus can be air-breathing and may periodically or continually intake surrounding air for analysis. A sample S from the air is conveyed through the sample collection system 24. The light L interacts with the sample S to generate Raman spectrometry data. The sample S is then conveyed into the mass spectrometer 22, where mass spectrometry data is collected. The mass spectrometer 22 and the Raman spectrometer 26 can be connected with a processing device in a known manner, such as a computerized device having hardware, software, or both, for collecting and analyzing the data. The apparatus 20 thus provides the ability to analyze a sample S using two different spectrometry techniques.

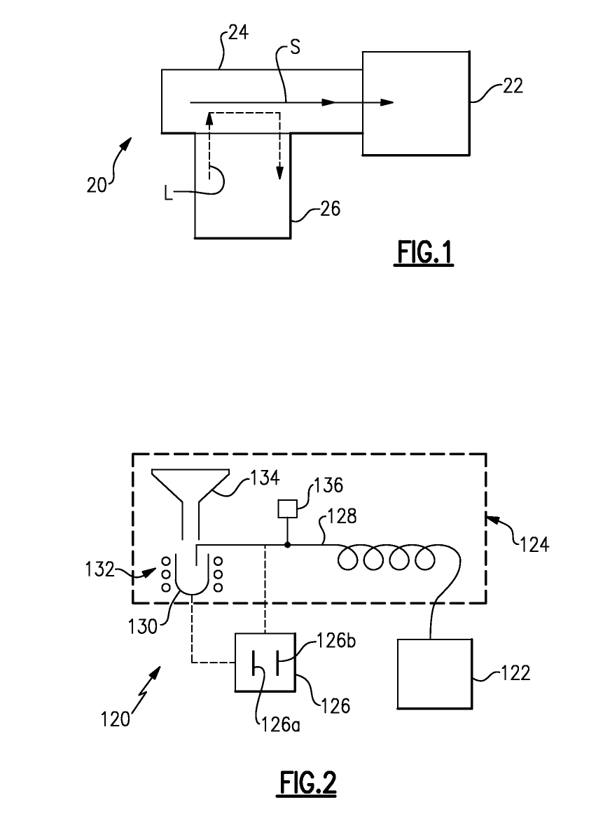

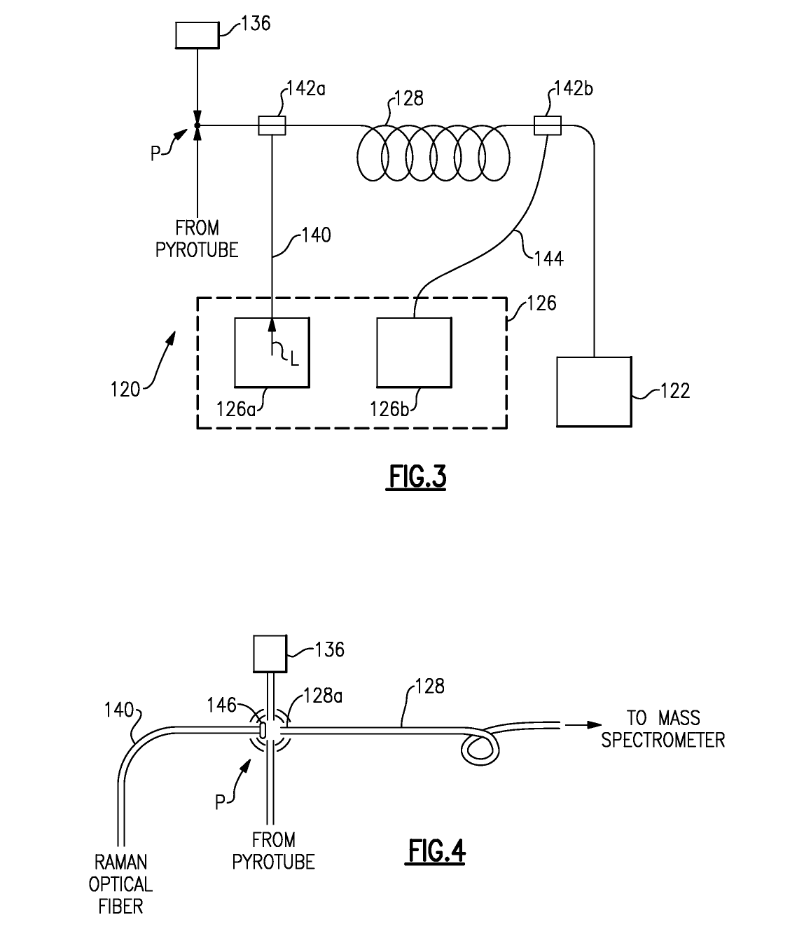

FIG. 2 illustrates another example dual-spectroscopy detection apparatus 120 (hereafter “apparatus 120”). In this disclosure, like reference numerals designate like elements where appropriate and reference numerals with the addition of one-hundred or multiples thereof designate modified elements that are to be understood to incorporate the same features and benefits of the corresponding elements.

In this example, the apparatus 120 includes a mass spectrometer 122, a sample collection system 124 and a Raman spectrometer 126. The sample collection system 124 includes a capillary 128 and a pyrotube 130 with a heater coil 132. The heater coil 132 may be used to pyrolize the sample S to vapor. The capillary 128 can be a hollow fiber, and may or may not be free of internal coatings/packings that are normally used in chromatography with mass spectrometry. A sample bio-concentrator 134 is provided near the pyrotube 130 and serves to collect and concentrate biological sample matter into the pyrotube 130. A chemical collector 136 can be provided for collecting and providing chemical sample matter into the capillary 128. As shown in some arrangements herein, the Raman spectrometer 126 is operatively connected with the capillary 128. In other alternative arrangements, the Raman spectrometer 126 is operatively connected with the pyrotube 130. Also, the Raman spectrometer 126 includes a laser light source 126a and an analysis portion 126b, as will be described in more detail with reference to FIG. 3.

FIG. 3 shows a variation of the apparatus 120 with the Raman spectrometer 126 operatively connected with the capillary 128. In this example, the chemical collector 136 and pyrotube 130 are coupled at a joint connection point P to provide the sample to the capillary 128. As described above, the Raman spectrometer 126 includes a laser light source 126a and an analysis portion 126b. The laser light source 126a is coupled to the capillary 128 through an optical fiber 140 and a first coupling 142a. A second coupling 142b provides for removal of the Raman-scattered laser light from the capillary 128 into another optical fiber 144 and the analysis portion 126b. The first coupling 142a and the second coupling 142b are spaced apart with regard to the elongated direction of the capillary 128. Alternatively, the arrangement can be reversed such that the laser light L is provided through the optical fiber 140 from the laser light source 126a into the second coupling 142b and removed from the capillary 128 through the first coupling 142a to the optical fiber 144 and analysis portion 126b (i.e., counter to the flow direction of the sample through the capillary 128 into the mass spectrometer 122).

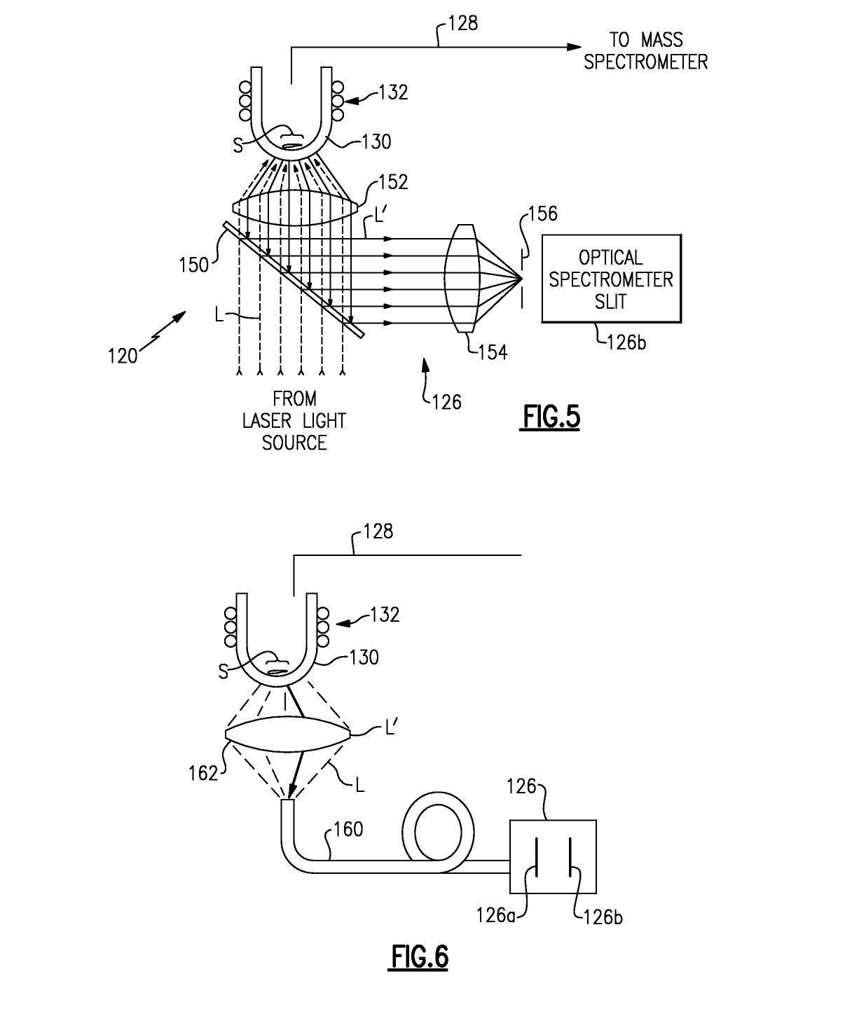

FIG. 4 shows a portion of the apparatus 120 in a variation where the laser light source 126b of the Raman spectrometer 126 is operatively coupled at the joint connection point P. In this example, the Raman spectrometer 126 is operatively coupled through a single optical fiber 140 that is aligned with an inlet, free end 128a of the capillary 128. The single optical fiber 140 thus delivers laser light and receives Raman-scattered laser light from the capillary 128. Optionally, a lens 146 can be used to focus the laser light to enhance coupling.

FIG. 5 shows a portion of the apparatus 120 in a variation where the Raman spectrometer 126 is operatively connected with the pyrotube 130. In this example, a beamsplitter 150 and a lens 152 are provided adjacent the pyrotube 130. Laser light L from the laser light source 126a is provided through the beamsplitter 150, and the lens 152 focuses the laser light L on the sample S in the pyrotube 130. The beamsplitter 150 directs returning scatter light L′ from the sample S toward another lens 154, which concentrates the light L′ onto a slit 156 for transmittance into the analysis portion 126b of the Raman spectrometer 126.

FIG. 6 shows a portion of the apparatus 120 in another variation where the Raman spectrometer 126 is operatively connected with the pyrotube 130. In this example, the laser light source 126a of the Raman spectrometer 126 is coupled with the pyrotube 130 through an optical fiber 160. The Raman spectrometer 126 thus can be somewhat remotely located. A lens 162 is provided adjacent the pyrotube 130 and serves to focus the laser light L with respect to the sample S in the pyrotube 130. The scatter laser light L′ from the sample S is returned through the optical fiber 160 to the analysis portion 126b of the Raman spectrometer 126.

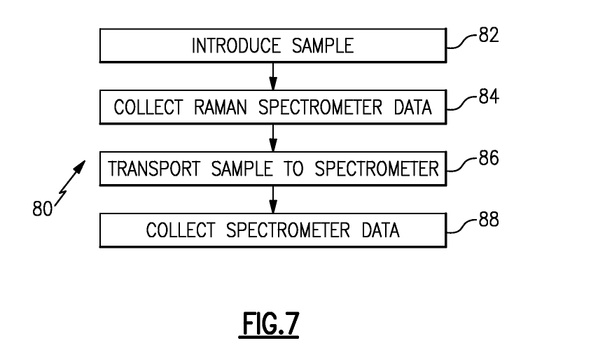

FIG. 7 schematically shows an example method 80 for dual-spectroscopy, the details of which have also been described above with regard to FIGS. 1-6. In a basic form, the method 80 includes step 82 of introducing the sample collection system 24, step 84 of collecting Raman spectrometer data from the sample at a location in the sample collection system 24, step 86 of transporting the sample from the sample collection system 24 into the mass spectrometer 22/122 and step 88 of collecting spectrometer data from the sample in the mass spectrometer 22/122.

In a further example of the method 80, the sample S can be analyzed either prior to, during, or after pyrolysis of the sample S in the pyrotube 130 using the heater coil 132. That is, the Raman spectroscopy data can be collected prior to heating the sample S, during pyrolysis, or after vaporizing the sample S using the heater coil 132. In another alternative, the sample S can be analyzed both before and after vaporization.

The spectroscopy data collected from the mass spectrometer 22/122 and the Raman spectrometer 26/126 can then be analyzed and compared to determine whether a targeted composition exists or not. For example, the mass spectrometer 22/122 is suited for detecting and identifying non-biological molecules, but can generate false positive or negative indications for the presence of biological molecules or organisms. However, when coupled with the functionality of the Raman spectrometer 26/126, the data from the two spectrometers can be compared to thereby reduce the number of false positive or negative indications that would otherwise be generated if only one spectrometer was used. In this case, since Raman spectrometry is suited for the detection and identification of biological molecules or organisms, the Raman spectroscopy data can be used to independently verify the spectrometry data from the mass spectrometer 22/122 with respect to the positive or negative identification of such molecules or organisms. Thus, the examples herein provide for enhanced detection of non-biological molecules using the mass spectrometer 22/122 and biological molecules or organisms using the Raman spectrometer 26/126.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A dual-spectroscopy detection apparatus comprising:
a mass spectrometer;
a sample collection system connected to the mass spectrometer; and
a Raman spectrometer that is operatively coupled with the sample collection system.

2. The apparatus as recited in claim 1, wherein the sample collection system includes a capillary, and the Raman spectrometer is operatively coupled with the capillary.

3. The apparatus as recited in claim 2, wherein the Raman spectrometer is operatively coupled at a first coupling along the capillary and a second, different coupling along the capillary that is spaced apart from the first coupling.

4. The apparatus as recited in claim 1, wherein the sample collection system includes a capillary having a free end, and the Raman spectrometer is operatively coupled with the capillary through a single optical fiber having an end that is aligned with the free end of the capillary.

5. The apparatus as recited in claim 1, wherein the sample collection system includes a pyrotube, and the Raman spectrometer is operatively coupled with the pyrotube.

6. The apparatus as recited in claim 4, wherein a capillary from the pyrotube is coupled to a capillary from a chemical collector through a joint connection.

7. The apparatus as recited in claim 4, wherein the pyrotube includes a heater.

8. The apparatus as recited in claim 1, wherein the Raman spectrometer is operatively coupled with the sample collection system through a single optical fiber.

9. The apparatus as recited in claim 1, wherein the sample collection system includes a pyrotube, and the Raman spectrometer is operatively coupled with the pyrotube through a single optical fiber.

10. The apparatus as recited in claim 1, wherein the sample collection system includes a sample concentrator.

11. The apparatus as recited in claim 1, wherein the Raman spectrometer is operatively coupled with the sample collection system through a beamsplitter adjacent the sample collection system.

12. The apparatus as recited in claim 1, wherein the Raman spectrometer is operatively coupled with the sample collection system through a lens adjacent the sample collection system.

13. The apparatus as recited in claim 12, wherein the beamsplitter is operatively coupled to a second lens for concentrating scatter light into the Raman spectrometer.

14. A method for dual-spectroscopy, the method comprising:
introducing a sample into a sample collection system;
collecting Raman spectrometer data from the sample at a location in the sample collection system;
transporting the sample from the sample collection system into a mass spectrometer; and
collecting spectrometer data from the sample in the mass spectrometer.

15. The method as recited in claim 14, including collecting the Raman spectrometer data prior to pyrolysis of the sample in the sample collection system.

16. The method as recited in claim 14, including collecting the Raman spectrometer data after pyrolysis of the sample in the sample collection system.

17. The method as recited in claim 14, including collecting the Raman spectrometer data during pyrolysis of the sample in the sample collection system.

18. The method as recited in claim 14, wherein the location in the sample collection system is at a capillary.

19. The method as recited in claim 18, including introducing light from the Raman spectrometer into the capillary at a first location and discharging light from the capillary at a second, different location that is spaced apart from the first location.

20. The method as recited in claim 18, including introducing light from the Raman spectrometer into the capillary through a single optical fiber from the Raman spectrometer, the single optical fiber having an end that is aligned with the free end of the capillary, and receiving backscattered light from the capillary into the single optical fiber.

21. The method as recited in claim 14, wherein the location in the sample collection system is at a pyrotube.

22. The method as recited in claim 14, including comparing the Raman spectrometer data and the spectrometer data, and based on the comparison determining whether the sample includes a biological organism or bio-chemical.
